(19) United States
(12) Patent Application Publication
(10) Pub. No.: US 2006/0122997 A1
(43) Pub. Date: Jun. 8, 2006

(54) System and method for text searching using weighted keywords

(76) Inventor: Dah-Chih Lin, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/001,778

(22) Filed: Dec. 2, 2004

(51) Int. Cl. G06F 7/00; G06F 17/30

(52) U.S. Cl. 707/5

(57) ABSTRACT

A system for text searching. The system comprises an interface, a search module, and a weighting module. The interface receives a search query comprising a plurality of keywords and weighting factors associated therewith. The search module executes a search process using the keywords, and generates a search result comprising a list of matched items. The weighting module arranges the items in the list using the weighting factors.

### BACKGROUND

The invention generally relates to database search engines for computer systems, and particularly to a system and method for searching text using weighted keywords, weighted concept words, or weighted sentences.

Database search engines allow searches to be performed on a set of documents via keywords. Users typically submit one or more keywords according to a format specified by the corresponding search engine. The searches provided by most of the search engines are typically based on the principles of Boolean logic. In a Boolean search query, Boolean operators are used to specify logical relationship among keywords. “AND”, “OR”, “NOT” are the typically used operators. A query “X AND Y” is to find text documents including both words X and Y; a query “X OR Y” is to find text documents including either word X or word Y; a query “X AND NOT Y” is to find text documents including word X but no word Y. In such conventional Boolean searching, each keyword in a search query is assigned and treated equally in performing a search. The engine does not distinguish the significance of one keyword from another. In the above example, the words X and Y are given the same significance, or the same weighting.

A search engine with the simplest intelligence is not capable of identifying different forms of the same word. For example, “racket” and “racquet” are deemed two different words. A more advanced search engine can recognize different spelling of the same word, singular and plural forms, and different tenses, etc. An even more advanced search engine can correlate a word to its synonyms, or to words with relevant meaning. In the latter case, the search engine does not only match the keyword in a query with an exact occurrence of the same word (or its various forms) in a text document, but also matches the keyword with a relevant word. For example, it does not only match “conducting” to “conductive”, but also correlate the word to “connection”, “electrical”, etc., with a relatively lower matching score than synonyms of the word. The engine calculates a total score of the matched exact words and relevant words, and rank the texts found to be relevant to the search query according to the total score. Such searches are hereinafter referred to as “concept searches”, and keywords used in such concept searches are referred to as “concept words”. The term “keywords” will be used hereinafter as a general term to include both “ordinary keywords” for basic matching searches and “concept words” for concept searches.

In concept searches, the Boolean operators are relatively unimportant. A concept search is more of a ranking process by the total score of each document, than a searching process to identify documents that exactly meet the query.

From users' perspective, many of the times users will retrieve more than dozens of documents through a search. Users normally read through the documents according to the order ranked and displayed by the search engine. Therefore, it is of great importance for a search engine to not only find the documents, but also rank the retrieved documents according to their relevance to the given query.

There have been many sophisticated methods to calculate the relevance of each document to a given query, which are used in concept search engines and in some of the basic search engines. However, a blind spot exists in all such engines, either for basic, advanced, or concept searches.

As in conventional Boolean searches, concept search engines also treat every meaningful keyword equally, even though a search query may comprise keywords of different significance. Although some concept search engines will omit words of no significance in a query, such as prepositions, the rest of the words in a query will be treated equally with no distinction. Thus a search result may deviate from expectations. For example, when the search is based on keywords of greatly differing importance, an inaccurate search result may be obtained. A document with zero occurrence of more significant keywords but with many occurrences of less significant keywords may be assigned a higher score due to the greater number of total occurrences of the keywords. Conversely a document containing the more significant keywords may be assigned a lower score if the total occurrences of the keywords are low.

### SUMMARY

Embodiments of the invention provide a system and method for text searching based on keywords associated with weighting factors.

An embodiment of the invention provides a system for text searching. The system comprises an interface, a search module, and a weighting module. The interface receives a search query comprising a plurality of keywords and associated weighting factors. The search module executes a search process based on the keywords, and generates a search result comprising a list of items. The weighting module arranges the items in the list using the weighting factors.

Also disclosed is a method of text searching. A search query is provided, comprising a plurality of keywords and associated weighting factors. A search process is executed based on the keywords, and generates a search result comprising a list of items. The items in the list are arranged according to the weighting factors.

### DESCRIPTION OF THE DRAWINGS

The invention can be more fully understood by reading the subsequent detailed description and examples with references made to the accompanying drawings, wherein:

FIG. 1 shows an embodiment of an exemplary computer system;

FIG. 2 is a schematic view of the search service system according to an embodiment of the invention;

FIG. 3 is a flowchart showing the method of performing the search service according to an embodiment of the invention; and

FIG. 4 is a brief block diagram of a browser window or screen according to an embodiment of the invention.

### DETAILED DESCRIPTION

In the following detailed description of an embodiment, reference is made to the accompanying drawings which form a part hereof, and in which is shown by way of illustration specific embodiments in which the invention may be practiced. These embodiments are described in sufficient details to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense, and the scope of the present invention is only defined by the appended claims. The leading digit(s) of reference numbers appearing in the Figures corresponds to the Figure number, with the exception that the same reference number is used throughout to refer to an identical component which appears in multiple Figures.

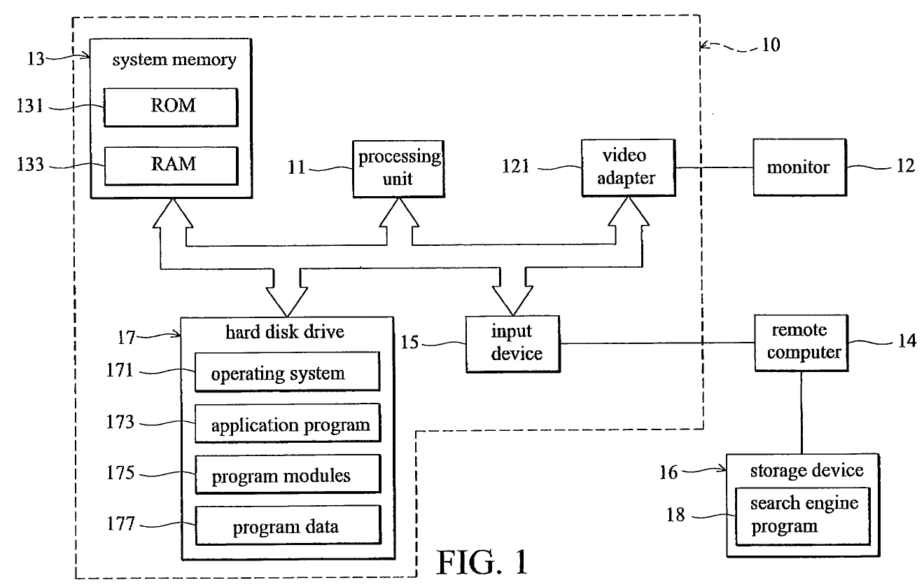

FIG. 1 provides a brief, general description of a suitable computing environment in which an embodiment of the invention may be implemented. The invention will hereinafter be described in the general context of computer-executable program modules, containing instructions executed by a personal computer (PC). Program modules include routines, programs, objects, components, data structures, etc. performing particular tasks or implementing particular abstract data types. Those skilled in the art will appreciate that the invention may be practiced with other computer-system configurations, including hand-held devices, multiprocessor systems, microprocessor-based programmable consumer electronics, network PCs, minicomputers, mainframe computers, and the like.

FIG. 1 illustrates a general-purpose computing device in the form of a personal computer 10, which comprises processing unit 11, system memory 13, and system bus 19. The system bus 19 couples the system memory 13 and other system components to processing unit 11. System bus 19 may be any of several types, including a memory bus or memory controller, a peripheral bus, and a local bus, and may use any of a variety of bus structures. System memory 13 includes read-only memory (ROM) 131 and random-access memory (RAM) 133. A basic input/output system (BIOS), stored in ROM 131, contains the basic routines that transfer information between components of personal computer 10. Personal computer 10 further comprises hard disk drive 17 for reading from and writing to a hard disk (not shown). The drive and its associated computer-readable media provide nonvolatile storage of computer-readable instructions, data structures, program modules and other data for personal computer 10. Although the exemplary environment described herein employs a hard disk, those skilled in the art will appreciate that other types of computer-readable media which can store data accessible by a computer may also be used in the exemplary operating environment. Such media may include magnetic disks, optical disks, magnetic cassettes, flash-memory cards, digital versatile disks, and the like. Program modules may be stored on the hard disk 17, ROM 131, and RAM 133. Program modules may include operating system 171, one or more application program 173, other program modules 175, and program data 177. A user may enter commands and information into personal computer 10 through input device 15, such as a keyboard, pointing device, microphone, joystick, and the like. A monitor 12 or other display device also connects to system bus 19 via an interface such as a video adapter 121.

Personal computer 10 may operate in a networked environment using logical connections to one or more remote computers such as remote computer 14. Remote computer 14 may be another personal computer, a server, a router, a network PC, a peer device, or other common network node. It typically includes many or all of the components described above in connection with personal computer 10, however, only a storage device 16 is illustrated in FIG. 1. The storage device 16 stores a search engine program 18, which provides a web-based search service to the personal computer 10. The remote computer 14 is connected to personal computer 10 through a local-area network (LAN) and/or a wide-area network (WAN) When placed in a LAN networking environment, personal computer 10 connects to the local network through a network interface or adapter (not shown). When used in a WAN networking environment such as the Internet, personal computer 10 typically includes a modem or other means for establishing communications over a WAN. In a network environment, program modules depicted as residing with personal computer 10 or portions thereof may be stored in remote storage device 16. Of course, the network connections described are illustrative, and other means of establishing a communications link between the computers may be substituted.

The application program 173 in the personal computer 10 includes one of any commonly available software applications, such as a browser, used to locate and display web pages. Using the browser, a user accesses the system of the present invention.

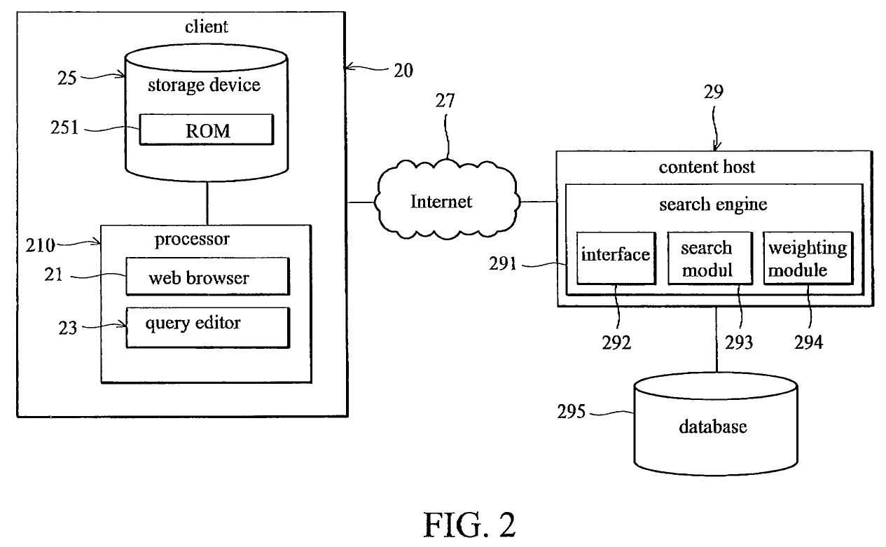

FIG. 2 is a schematic view of the search service system according to an embodiment of the invention. In FIG. 2, two commuters are shown in a typical Internet based network incorporating the system of accessing search services disclosed here.

A client 20 is a web client running one of many commonly available software applications used to locate and display web pages. Web pages are meant to describe any type of content that resides on a computer which may be viewable by a client computer. Typically today, the Internet is a networked group of computers which share information stored on them in many different ways. The use of the term Internet and Web are not meant to be limited to the forms in which they currently exist. The invention is applicable to any type of network having information which may be viewed or transferred between computers. In one embodiment, the software applications running on a processor 210 include a web browser 21 and a query editor 23. The web browser 21 provides an interface for receiving information input by a user. The query editor 23, connected to web browser 21, uses the information received by web browser 21 to generate a corresponding search query. The web browser 21 receives the search query, transmits it to a content host 29 via Internet 27, and retains a record of each search query (query record 251) in a storage device 25. The search query comprises at least one keyword, where if there are two or more keywords, they may be associated with at least one Boolean operator specifying logical relationship therebetween, and each keyword is assigned a weighting factor specifying significance thereof for a particular search. The weighting factor of a keyword may be assigned by a user, or, if in lack of a user's input, may be assigned a default value. In addition to expressing the search query in the form of a Boolean logic formula, to be more user-friendly, the search query may simply be a sentence or multiple sentences. In this case, the user may use an input device (not shown) to assign weighting factors to one, some, or all the words contained in the sentence or sentences.

The client 20 is coupled through Internet 27 to content host 29. The content host 29 comprises a search engine 291 that provides search capabilities for content stored on a database 295. The database 295 may be plain storage, or any form of database capable of providing content and being searchable. The search engine 291 receives search commands from information entered by a user on the client 20 and executes the commands to retrieve desired content.

The search engine 291 comprises an interface 292, a search module 293, a weighting module 294, and optionally a pre-processing module 295. The interface receives a search query transmitted from client 20, wherein if the search query is a keyword search query, it comprises a plurality of keywords, at least one Boolean operator specifying logical relationship between keywords, and weighting factors associated with each of the keyword. The search module 293 executes a search process using the keywords, and generates a search result comprising a list of items, which for example may simply be the indices relating to the documents found relevant to the search query, or may further include (but are not limited to) the titles, document numbers, representative paragraphs, etc. of the documents. The search may be, but is not limited to, exact keyword matching search, more advanced keyword search, or concept search. If the search query is a sentence or multiple sentences, the pre-processing module 295 disassembles the sentences into a plurality of meaningful keywords and omits insignificant words according to a predetermined vocabulary setting. If the search is a basic or advanced keyword search, the pre-processing module 295 assigns a default Boolean operation formula to the meaningful keywords, which, for example, may be connecting all the keywords by “AND” or “OR”. If the search is a concept search, the pre-processing module 295 does not necessarily need to assign a Boolean operation formula to all the meaningful keywords (concept words in this case) . The keywords and their Boolean operation relationship, or the concept words, are sent from pre-processing module 295 to the search module 293 for carrying out the search process as described above.

Concurrently or after the list of items is completely generated, the weighting module 294 arranges the items in the list using the weighting factors. In concept searches where there is no Boolean logic operation assigned, the result list of items is the whole database or a predetermined subset thereof. The weighting module 294 arranges the ranking of the items.

After the search is complete, the search engine 291 sends the search result to the client 20. The search result is generally a long list of hyperlinks corresponding to web pages that match a keyword specified by the user. The web browser 21 displays the search result in a browser window.

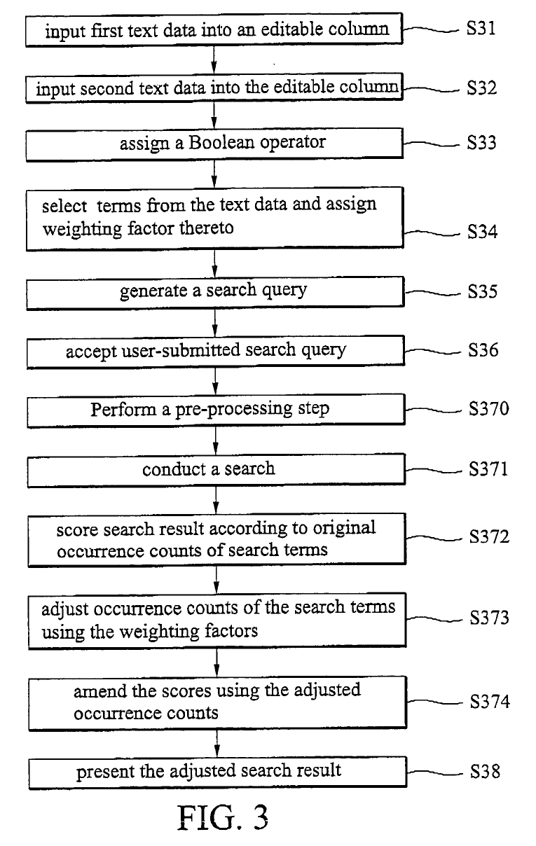

FIG. 3 is a flowchart showing the method of performing search services of an embodiment of the invention. A user inputs a search query for a search engine 251 conducting a search. The search query may comprise a plurality of keywords or keywords, some of which are assigned corresponding weighting factors, and at least one Boolean operator specifying logical relationship between the keywords. Alternatively, the search query may be a sentence or sentences.

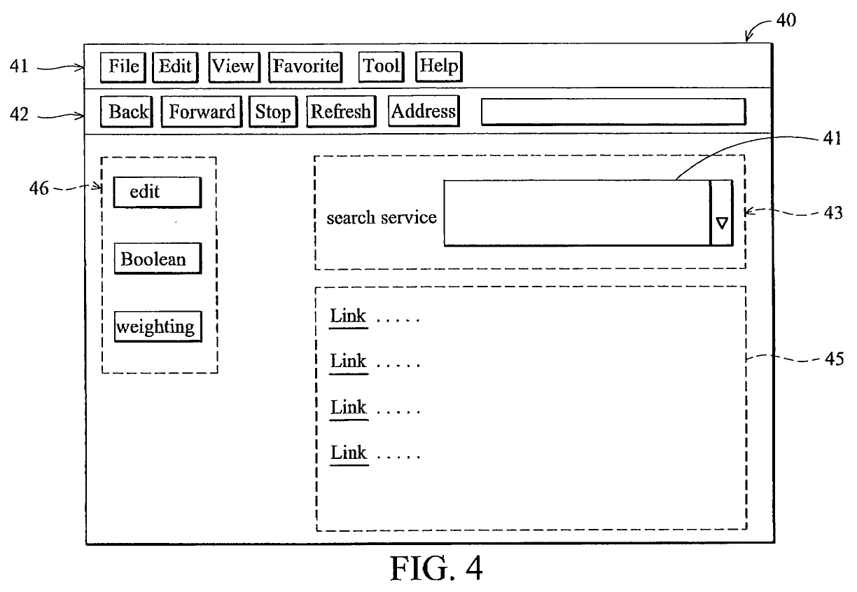

More specifically, in step S31, a user inputs first text data, which may be keywords with a Boolean logic formula. Or, alternatively, the user may simply copy, for example an abstract of an article, and paste it into an editable column 41 on a screen 40 (illustrated in FIG. 4). The text data can be any text of any length. Next, optionally, the user may input second text data in column 41 (step S32), and uses a Boolean operator to specify logical relationship between the first and second text data (step S33). The Boolean operators comprise logical operators, such as “AND”, “OR”, and “NOT”, and some supplementary operators, such as “NEAR” and parentheses. The user selects some words from the input text data and marks the selected words with different labels (step S34), wherein each label corresponds to a weighting factor with a particular value. The “labels” of the selected words may be expressed by, for example, different colors, fonts, underlines, etc. According to the embodiment, three different labels are applied and corresponding to weighting factors 10, 5, and 3, respectively. The unselected part of the text data is not labeled and assigned a weighting factor 1. Values of the weighting factors can be defined in various ways. For example, it can be defined by a user, by predetermined default value, by following previous query settings, or by statistical calculation of all or some previous query settings.

Preferably, a query editor 23 at the client 20 generates a search query according to the information input by the user (step S35). The search query comprises a plurality of keywords associated with weighting factors, and Boolean operators specified by the user. However, it is also possible that the query is sent to the interface 292 as it is without further processing.

The interface 292 accepts user-submitted search query from client 20 via Internet 27 (step S36). In case necessary, a pre-processing step is taken by the pre-processing module 295 (step 370). The search module 293 conducts a search to select files that meet all or part of the search query (step S371). A search result obtained by search module 293 comprises a list of items corresponding to matched data files found in the search process. According to one embodiment of this invention, in an initial stage, the matched data files are scored according to original occurrence counts of keywords obtained from the search process (step S372). The original occurrence counts of the keywords in a particular file are further adjusted using the weighting factors (step S373) . The ranking order of the files are rearranged using the adjusted occurrence counts (step S374). Alternatively, steps 372-374 may be done in a real-time feedback adjustment mode rather than sequentially. It should also be noted that the scoring of the files may be based on a more sophisticated formula taking into account not only the occurrence counts, but also keyword usage ratios, distances between keywords, clustering of keywords, etc.

An adjusted search result comprising a ranking list according to adjusted scores is sent to client 20 (step S38).

The adjusted search result, preferably including network hyperlinks of the files found to at least partly meet the query, is then displayed on a first browser window presented to the user on the client 20 (step S39). The user views the search result presented in the first browser window and checks some web pages to see whether the found web pages are relevant. If the user considers one or more of the web pages to be irrelevant, a new set of keywords and/or weighting factors can be assigned, and a new round of search process is performed.

FIG. 4 shows a brief block diagram of a browser window or screen presented to a user according to an embodiment of the invention. The content host 29 provides the basic html or other format of tag based language to client 20 with browser 21 which generates a screen 40. Screen 40 comprises a standard operating system command line 44 and browser navigation buttons 42. Screen 40 is made up of multiple frames, providing different type of tools and information. The actual arrangement of the frames and other content of this page may vary as desired. A frame 43 is a search service frame which provides search features such as an editable column for search request entry and a button for starting the search labeled “go”. On the left side of the screen 40 is a frame 47, providing several functional buttons for activating the function of the query editor 23, such as editing text data in the search query, adding Boolean operators, and assigning weighting factors, respectively. In response to a user entering a search query, a list of hyperlinks is provided in a frame 45.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) . Therefore, the scope of the appended claims should be accorded the broadest interpretation so as to encompass all such modifications and similar arrangements.

What is claimed is:

1. A system for text searching, comprising:
an interface receiving a search query comprising at least one keyword and a weighting factor associated therewith;
a search module executing a search process based on the at least one keyword, and generating a search result comprising a list of matched items; and
a weighting module arranging the ranking order of the items in the list according to the scores of the items calculated using the weighting factor.

2. The system of claim 1, wherein the search executed by the search module is a keyword matching search.

3. The system of claim 1, wherein the search executed by the search module is a concept search.

4. The system of claim 1, wherein the search query further comprises a Boolean operator specifying logical relationship between the keywords.

5. The system of claim 1, wherein the search query comprising a sentence.

6. The system of claim 5, further comprising a pre-processing module to disassemble a sentence of a search query into a combination of keywords.

7. The system of claim 1, wherein the weighting factor of the at least one keyword is user-defined.

8. The system of claim 1, wherein the weighting factor of the at least one keyword is determined by preset settings.

9. The system of claim 1, wherein the weighting factor of the at least one keyword is determined according to previously used settings.

10. The system of claim 8, wherein the weighting factors are determined by statistical calculation results from the previously used settings.

11. The system of claim 1, wherein two or more keywords are used, and two or more weighting factors with different values are used, specifying different significance of the corresponding keywords.

12. The system of claim 1, wherein the interface comprises a tool for labeling the at least one keyword to assign a specific weighting factor thereto.

13. The system of claim 1, wherein the search module further provides a list of top-scored items.

14. A method of text searching, comprising:
obtaining a query, comprising a plurality of keywords and weighting factors associated therewith;
executing a search process based on the keywords, and generating a search result comprising a list of matched items; and
arranging the ranking order of the items in the list according to the scores of the items calculated using the weighting factors.

15. The method of claim 14, wherein the search process executed is a keyword matching search.

16. The method of claim 14, wherein the search process executed is a concept search.

17. The method of claim 14, wherein the search query further comprises a Boolean operator specifying Boolean relationship among the keywords.

18. The method of claim 14, further comprising, prior to the step of obtaining a query, receiving a search request comprising a sentence, and disassembling the sentence into a combination of keywords.

19. The method of claim 18, wherein the disassembling step omits words of no significance to a search.

20. The method of claim 14, wherein the weighting factors are user-defined.

21. The method of claim 14, wherein the weighting factors are determined by preset settings.

22. The method of claim 14, wherein the weighting factors are determined according to previously used settings.

23. The method of claim 21, wherein the weighting factors are determined by statistical calculation results from the previously used settings.

24. The method of claim 14, wherein the weighting factors are of different values specifying different significance of the corresponding keywords.

25. The method of claim 14, further comprising the step of labeling the keywords to assign specific weighting factors thereto.

26. The method of claim 14, further comprising the step of providing a list of top-scored items.
